(19) United States
(12) Patent Application Publication
(10) Pub. No.: US 2007/0094278 A1
(43) Pub. Date: Apr. 26, 2007

(54) Data transfer services

(76) Inventors: Andreas Huppert, Erfweiler-Ehlingen (DE); Joerg Steinmann, Voelklingen (DE); Dirk P. Wagner, Schiffweiler (DE)

Correspondence Address: KENYON & KENYON LLP, ONE BROADWAY, NEW YORK, NY, 10004, US

(21) Appl. No.: 11/256,044

(22) Filed: Oct. 21, 2005

(51) Int. Cl. G06F 7/00

(52) U.S. Cl. 707/100

(57) ABSTRACT

Data transferring using a data management application includes transferring only the needed data and performing the transfer in parallel. In the technique, the data transfer command is received, where this command includes an indication of what data is to transferred. Based on this command, one or more of the data fields stored within a data storage location associated with the data management application are designated for transfer. These designated fields are then transferred from a database format to an open format. After conversion, the converted data fields are then transferred in parallel to a temporary buffer. After completing the transfers of the converted data fields, the contents of the temporary buffer are written to a memory location associated with an external application.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office patent file or records, but otherwise reserves all copyright rights whatsoever.

### BACKGROUND OF THE INVENTION

The present invention relates generally to data transfer and more specifically to the transfer of data, such as importing or exporting data, using a data management application.

Incumbent with existing data management applications is the large amounts of data used with this application. Typically, there may be a central data storage location holding a large amount of the data and the data can be disseminated within the application framework as needed. Using the example of an inventory application, the data may be stored in a central location and when a user wishes to see how many widgets are in stock, this data is made available to the user, typically through a portal using a networked computer.

These data management applications act as a central repository to manage vast amounts of data using a central interface. This data is useful not only within the application but can be used externally as well. Therefore, these data management applications allow for the export of the data to other applications. Similarly, to quickly acquire data, these data management applications may also receive incoming data. This data importing and exporting may be done through an interface or other portal to the external application.

In order to facilitate the import and export of data with the data management application, functionality must be provided within the application itself. Typically, this data transfer is performed using encoded software instructions providing for a two step process. The first step is transforming the data to be transferred. In current sysems, the full data sets are converted. To export data, the data must be converted from the encoding format used by the data management application to a file format usable by the external application.

The second step in the process is to then transfer the converted data. In existing systems, this is done in a serial fashion. The data is either serially transferred into the database or serially transferred out of the database. In this serial approach, the full data set is exchanged. The data management application either receives the full designated data set or transfers out the full data set. Similarly, the transfer function is a straight forward data transfer function and does not provide any processing of the data.

In the current approach for exporting data, if an external application only needed several components of data, the external application would receive the full data set. For example, if the data set related to the above-noted example of inventory, the data set may include all the information about a particular product. If an external application wanted the data from the data management software application, the external application would receive all of the data in the data set even if it only needed one or a couple of the elements. Similarly, the data would be transferred in its existing order as stored in the database.

In the existing systems, the data management application focuses on the data itself. In a data transfer scenario, the data management application simply provides getting the data out of the application to allow the external application to use the data. In import scenarios, the focus is receiving the data and simply integrating it into the application. Importing and exporting is a secondary function to the purpose of the data management application.

While data management application focuses on the data itself over data transferring, this creates several problems. First off, the serial transfer approach restricts the speed at which data may be transferred. Secondly, the full data transfer may mean that extraneous data is transmitted when it is not needed. Therefore, not only is the data transfer rate limited by the serial data transfer technique, but the speed is further hampered by the sending of extraneous data.

Similarly, the existing data management applications focus primarily on how the data can be transferred and how it affects processing ability for the application itself. In this approach to get data into or out of the system in a simplified manner, there is no focus on what is being transferred. As importing and exporting data is a secondary function, existing data management software applications fail to provide functionality relating to improving the speed and efficiency of not only how data is transferred into and out of the application, but also what data itself is transferred.

### BRIEF DESCRIPTION OF THE DRAWINGS

FIG. 1 illustrates a block diagram of one embodiment of an apparatus for transferring data using a data management application;

FIG. 2 illustrates a block diagram of one embodiment of the parallel data transfer using a data management application;

FIG. 3 illustrates a graphical representation of one embodiment of the parallel and selective data transfer;

FIG. 4 illustrates a flow diagram of one embodiment of exporting data using the data management application;

FIG. 5 illustrates a flow diagram of one embodiment of importing data using the data management application; and

FIG. 6 illustrates a flowchart of the steps of one embodiment of a method for transferring data using a data management application.

### DETAILED DESCRIPTION

Data transferring using a data management application includes transferring only the needed data and performing the transfer in parallel. In the technique, the data transfer command is received, where this command includes an indication of what data is to transferred. Based on this command, one or more of the data fields stored within a data storage location associated with the data management application are designated for transfer. These designated fields are then transferred from a database format to an open format. After conversion, the converted data fields are then transferred in parallel to a temporary buffer. After completing the transfers of the converted data fields, the contents of the temporary buffer are written to a memory location associated with the external application.

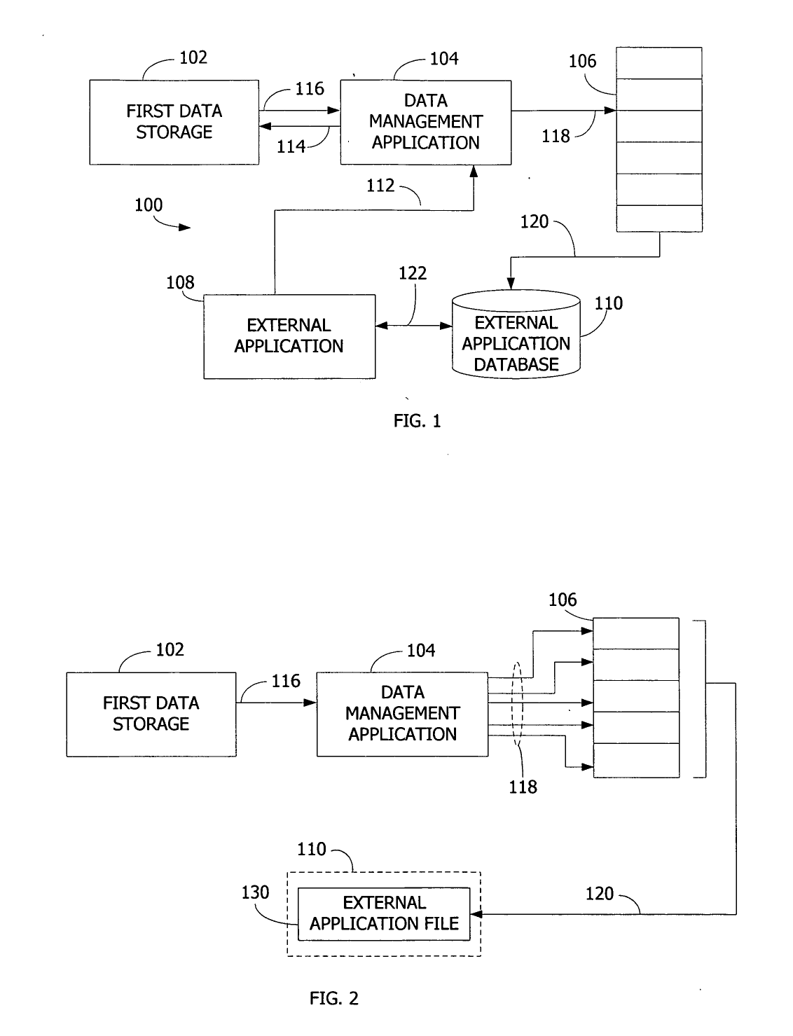

FIG. 1 illustrates one embodiment of an apparatus 100 for data transfer. The apparatus 100 includes a first data storage location 102, a data management application 104, a temporary buffer 106, an external application 108 and an external application database 110. The storage location 102 may be one or more memory locations associated with the data management application 104 where data stored therein is used by the application 104. The storage location 102 may be local to the application 104 or may be in a networked scenario across one or more locations depending on the networked structure of the data management application 104, as recognized by one having ordinary skill in the art.

The application 104 is typically one or more processing devices running executable instructions. The application 104 is typically user accessible through networked connections providing standard interfacing for a user to utilize the application 104. The application 104 is also executable based on encoded instructions encoded using a data management encoding format, which may be a proprietary format. One exemplary embodiment may include the instructions being encoded in ABAP available from SAP. The data management application 104 may operate similar to known data management applications, such as a customer resource management (CRM) application but includes additional functionality associated with data transfer techniques.

The temporary buffer 106 may be any suitable type of memory location available to temporarily store data provided from the data management application 104. The buffer 106 is structured to allow multiple data accesses in a simultaneous fashion allowing for parallel data transfer.

The external application 108, similar to the data management application 104, may be a software application including multiple functions defined by executable instructions contained within software code. The external application 108 may be any suitable type of application that uses or otherwise accesses the data management application 104. The external application 108 may also be encoded in any available encoding format and is able to read or process data in an open format, where an open format is any format not specifically restricted by propriety restrictions. For example, the open format may be XML format or a CSV format. The external application database 110 may be any type of memory structure capable of storing data used by the external application 108.

In the apparatus 100 of FIG. 1, the external application 108 sends a data transfer command 112 to the data management application 104. Not specifically illustrated in FIG. 1, this command 112 may be transmitted across a networked connection and may be routed through intermediate devices using known routing techniques. In one embodiment, the command 112 includes an indication of the data that is to be exported. The indication may include an identification of data fields as well as an identification of partitioned fields, where partitioned fields are subsections of the data fields, as described in further detail below.

The data management application 104 sends a data retrieval request 114 to the storage device 102. In one embodiment, selected data fields may be indicated in the data request 114 and in another embodiment, a full data set may be retrieved and a selection of specified data may be done within the application 104. In response to the request, data fields 116 are provided to the data management application 104.

Data fields 116 are designated for transfer. This designation may be done by the retrieval request 114 selecting particular data fields or may be done by the application 104 selecting particular data fields from a full data set that may be retrieved from the memory 102. Once these data fields are designated, the data management application 104 performs a data conversion process, converting the data fields from the data management format to an open format. In one embodiment, the database formatted data fields may be encoded using a DDIC format. Similarly, in one embodiment, the data fields may be converted from the data management format to an XML or CSV format.

Once data is converted, the converted data is then ready for transfer. The data management application 104 significantly improves data transfer efficiency by performing parallel transferring of the database data to a temporary buffer. Using multiple transfer commands, the converted data 118 is then transferred in parallel to the temporary buffer 106. As discussed in further detail below, during this parallel transfer, the ordering of the data fields may also be adjusted.

After the full transfer of the converted data 118, the converted data set 120 may then be transferred to the external application database 110. From this database 110, the external application may then interact 122 with the database for using the converted data 120. In one embodiment, the converted data 120 is formatted in a file or other defined data structure that is usable by the external application. Through this technique, data is exported from the data management application 104 and selected data is transferred in parallel and eventually provided to the external application.

FIG. 2 illustrates a block diagram of another embodiment, more specifically illustrating the parallel data transfer 118. Similar to the embodiment described above with respect to FIG. 1, the data 116 is retrieved from the first data storage device 102. This data, upon being converted, is transferred in parallel 118 to the temporary buffer 106. In the illustrated embodiment of FIG. 2, five separate call functions are executed in parallel by the data management application 104, providing the five separate writes to the buffer 106. It is recognized that any other suitable number of parallel writes may be utilized. The amount of parallel transfer may be limited by the available bandwidth for transmitting data from the application 104 or the ability of the buffer 106 to receive the data 118.

Upon completion of the parallel data transfer, the converted data 120 is written to an external application file 130 associated with the external application. This file 130 is stored in the external application database 110. The file 130 is the collection of converted data 120 in a format readable and usable by the external application. In one embodiment, the file 130 may an XML file where the converted data has been converted into an XML format. In another embodiment, the file 130 may a CSV file where the converted data has been converted into a CSV format. It is recognized that other formats may be utilized, where the format of the data is usable by the external software application and the embodiments of XML and CSV formatting are exemplary in nature not meant to be as exclusively limiting as noted herein.

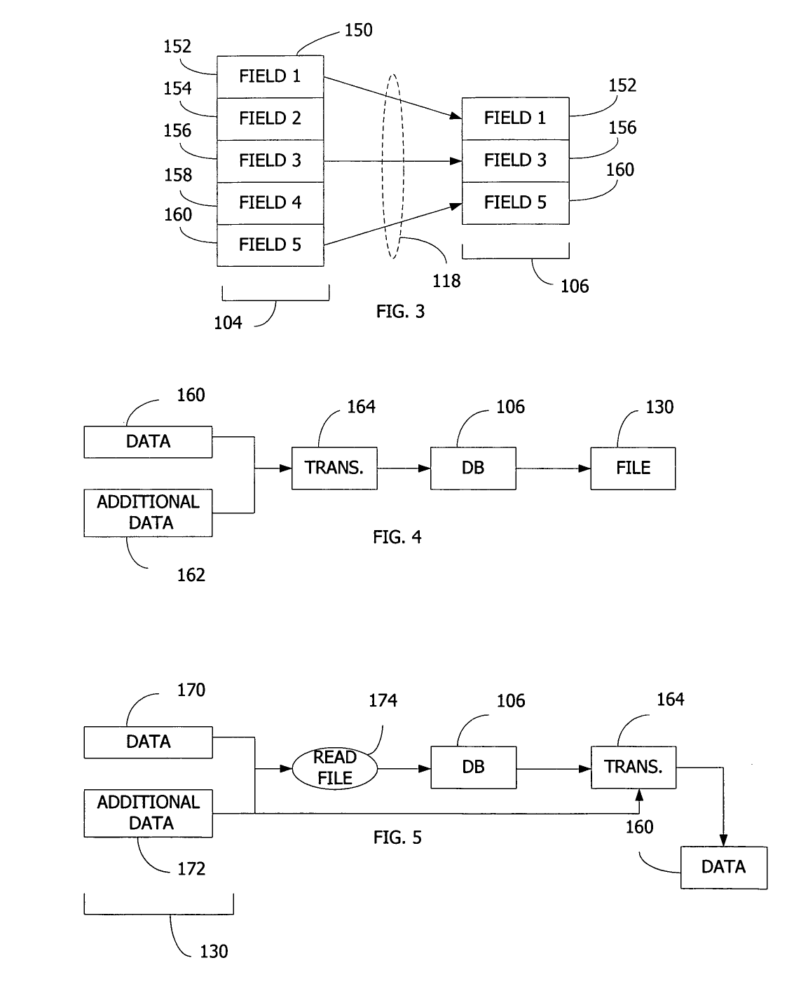

As discussed above, the data management application 104 improves the process of transferring data by not only including parallel data transfer, but also allows for the exclusion of the transfer of certain data fields. FIG. 3 illustrates an example of a data set 150 including five data fields, 152, 154, 156, 158 and 160 (collectively referred to as 152-160). These five data fields may be various elements within the data set. For example if the data set relates to customer information, the data fields 152-160 may refer to specific elements of information, such as name, address, type of business, telephone number and other information.

When the external application does not need all of the data fields in a data set, the data management application 104 may specifically exclude the conversion and transfer of data fields. A listing of preferred data fields for transferring may be included in the data transfer command. In another embodiment, a set of rules may be established based on existing relationships between the data management application and the external application. In another embodiment, an interactive user interface may be provided such that a user using the external application may be able to select the appropriate data fields. As recognized by one having ordinary skill in the art, other techniques are envisioned and within the scope of this disclosure.

FIG. 3 illustrates the parallel transfer 118 of the data fields, illustrated here as data field 1 152, data field 3 156 and data field 5 160. These data fields are transferred from the data management application to the temporary buffer 106, where the data fields may be converted data already converted into an open format. Therefore, as illustrated in FIG. 3, only specific data fields of a data set are transmitted, thereby reducing processing overhead by eliminating the transfer of extraneous data fields.

An aspect of the import and export services is in the data, the structure of the data and the format. For transferring data in both directions, import and export, the values may be manipulated before the output is written in an export scenario or the input is assigned to structure fields in an import scenario. Such a manipulation is part of a mapping functionality and can be accomplished using the data management formatting, such as with DDIC structures.

Mapping may be done using various techniques. In one embodiment, a user interface may be provided to allow the functionality. The mapping features provide for creating and updating of formats of type import/export and allowing a user to chose the target structure, rather than using the fixed and predefined external list management structure.

FIG. 4 illustrates a block diagram of one embodiment of the data flow in an export data transfer. The data flow includes data 160, additional data 162, a transformer 164, the buffer 106 and the data file 130. The process is separated into two steps. The first one is the transformation of the data, stored in data management encoded structures, into the output format. The second step is the writing of the transformed data to the file.

The data 160 is the set of data available for exporting, such as a plurality of data fields. The additional data 162 may be extraneous data that is within the system and used for various purposes. For example, the additional data may be a collection of symbols that can be used for separating the data entries, such as a semi-colon or other identifier. The additional data 162 may also be any other type of data that is not the data of the data field which may be used in facilitating the data export.

The transformer 164 may be a software module typically implemented within the data management application (104 of FIG. 1). The transformer 164 is operative to convert the data 160 from the data management format to an open format. The open format data may then be provided to the buffer 106, which is a temporary storage location. As discussed above, this data transfer from the transformer 164 to the buffer 106 is done in a parallel fashion.

Once all the data has been converted and transferred to the buffer 106, the data is then serially written to the data file 130, where the file is encoded in an open format and usable by an external application. The data can be split into three areas—header, body and footer. This is for supporting file formats, where the file content can have different areas. For example a CSV file can have up to two areas—a header and body area. The header area contains the field names, whereas the body contains the data. After the first process step (transformation of data) the data will be stored in database tables. Not until all data have been transformed will the data be written to the file. The reason for that is to support the parallel processing. This means that the transformation of data can be done in parallel mode, which boosts up the performance. The final step of writing the data to a file is done in non-parallel mode.

In one embodiment, the data management application may perform different processing steps to facilitate the data transformation and export. For example, the application might determine the format to be used for the exported data, determine the structure that should be used for exporting, including header data, body data and footer data. The application may also determine additional format specific information, such as a separator sign for example.

FIG. 5 illustrates an embodiment for the importing of data. The block diagram of FIG. 5 includes data 170 and additional data 172 which are included within the file 130, a read file execution step 174, the database 106, the transformer 164 and the data 160. The data 170 and the additional data 172 are encoded in the open format and the file is usable by an external application. The data 170 includes data fields and possible portions of the data fields. The additional data 172 includes extraneous information, such as a divider to define the data fields, similar to the additional data 162 of FIG. 4.

When the data is imported, the data management application performs the step of reading the file, where this step is illustrated at 174. The file 130 is read, extracting the data 170 and additional data 172. The extracted data is then provided to the temporary buffer 106, where the data is temporarily stored. Then, in a parallel fashion, the data in the temporary buffer 106 is provided to the transformer 164. Similar to the above-described embodiment, the transformer 164 converts the data from an open format to a data management format. As illustrated in FIG. 5, the transformer 164 also utilizes the additional data 172 to perform the transforming. This additional data 172 provides for transformation because the data 170 in the file 130 may include one or more portions of data, as described in the exporting embodiment above.

In the importing of data, one embodiment includes the steps of determining the format of the open format data, determine the structure that should be used for exporting, such as header data, body data and footer data. The steps further include determining additional format specific information, like the separator sign for example, creating mapping information for these structures, and announcing information to the services, including direction (import), format, structures/mapping and a status (e.g. started) field. A first part is to read and parse the file 130, including importing a header (to DB (stored temporarily)), importing the body (to DB (stored temporarily)), and import a footer (to DB (stored temporarily)). The next step may be to update a status field, e.g. finished the second part is to read temporary import items, transform data and provide it to the application, update the status (read from file) and delete all temporary information.

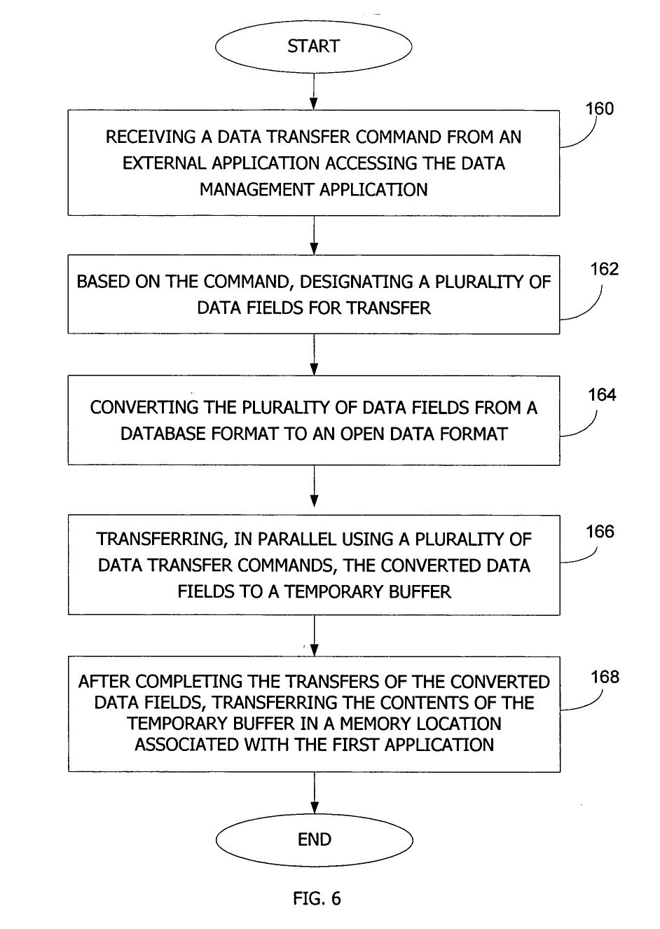

FIG. 6 illustrates the steps of a flowchart of one embodiment of a method for the transfer of data from a data management application. The first step, step 200, is receiving a data transfer command from an external application accessing the data management application. Similar to the data transfer command 112 of FIG. 1, the command includes instructions to receive various data sets usable by the external application. As noted above, this command is typically received across one or more network interfaces using known routing and data transfer protocols.

The next step, step 202, is based on the command, designating a plurality of data fields for transfer. The fields for transfer may be designated by being retrieved from a database associated with the data management application. This designation provides for determining which of the data sets within the data field are to be transmitted to the external application.

The next step, step 204, is converting the plurality of data fields from a data management format to an open data format. As noted above, the data fields are stored in the data management format, such as a DDIC structure. The data fields are converted into an open format, such as XML or CSV formats for example.

The next step, step 206, is transferring, in parallel using a plurality of data transfer commands, the converted data fields to a temporary buffer. Using multiple data push commands within the data management application, the converted data is transferred to the temporary buffer. Using parallel data transfer instead of a serial transfer significantly increases the speed at which the converted data is processed out of the data management application.

The final step in this embodiment, step 208, is after completing the transfers of the converted data fields, transferring the contents of the temporary buffer in a memory location associated with the external application. This step provides for the data to be available for the external application. Since the data is transferred in parallel to the temporary buffer, this step does not occur until step 206 is complete to insure that all the data in the temporary buffer is the proper data. Because the data transfer in step 206 is in parallel, there is no specific requirement that the data be transferred in any specific order. In a serial data transfer, it is typical for the data transfer to be from a first data field through the final data field. Although, with the parallel data transfer, a final serial data transfer of the data to the external application is insured by awaiting the completion of the parallel data transfer.

Therefore, through the inclusion of import and export services with a data management application, the transferring of data can be more efficiently performed. This transfer is improved through the use of determining selected data fields for transfer and the inclusion of a parallel transfer to a temporary buffer. Through this service, benefits located in a central data management application may be enjoyed by any one of a number external applications that work in conjunction with data management application. Similarly, the import and export services provide additional benefits within the data management application without having to modify the external application.

Although the preceding text sets forth a detailed description of various embodiments, it should be understood that the legal scope of the invention is defined by the words of the claims set forth below. The detailed description is to be construed as exemplary only and does not describe every possible embodiment of the invention since describing every possible embodiment would be impractical, if not impossible. Numerous alternative embodiments could be implemented, using either current technology or technology developed after the filing date of this patent, which would still fall within the scope of the claims defining the invention.

It should be understood that there exist implementations of other variations and modifications of the invention and its various aspects, as may be readily apparent to those of ordinary skill in the art, and that the invention is not limited by specific embodiments described herein. It is therefore contemplated to cover any and all modifications, variations or equivalents that fall within the scope of the basic underlying principals disclosed and claimed herein.

What is claimed is:

1. A method for transferring data using a data management application, the method comprising:
receiving a data transfer command from an external application accessing the data management application;
based on the command, designating a plurality of data fields for transfer;
converting the plurality of data fields from a data management format to an open data format;
transferring, in parallel using a plurality of data transfer commands, the converted data fields to a temporary buffer; and
after completing the transfers of the converted data fields, transferring the contents of the temporary buffer in a memory location associated with the external application.

2. The method of claim 1 wherein the data fields are converted into partitioned fields.

3. The method of claim 2 wherein the partitioned fields include at least one of: a header, a body, and a footer.

4. The method of claim 1 further comprising:
after converting the plurality of data fields, mapping the converted data fields to an export buffer.

5. The method of claim 6 wherein the mapping of converted data to the export buffer includes mapping the partitioned areas in a different order.

6. The method of claim 1 wherein the data fields in the database format are in a DDIC format.

7. The method of claim 1 wherein the open data format is at least one of: a CSV format and an XML format.

8. The method of claim 1 further comprising:
writing the converted data fields to a file associated with the external application, wherein the file is usable by the external application.

9. An apparatus for transferring data using a data management application, the apparatus comprising:
a first data storage location having a plurality of data fields stored therein;
a temporary buffer; and
a processing device in response to executable instructions, operative to:
receive a data transfer command from an external application accessing the data management application;
based on the command, designate a plurality of data fields in the first data storage location for transfer;
convert the plurality of data fields from a data management format to an open data format;
transfer, in parallel using a plurality of data transfer commands, the converted data fields to the temporary buffer; and
after completing the transfers of the converted data fields, transfer the contents of the temporary buffer to a memory location associated with the external application.

10. The apparatus of claim 9, the processing device further operative to convert the data fields into partitioned fields.

11. The apparatus of claim 10 wherein the partitioned fields include at least one of: a header, a body, and a footer.

12. The apparatus of claim 10 further comprising:
an export buffer coupled to the processor; and
the processor further operative to:
after converting the plurality of data fields, map the converted data fields to the export buffer.

13. The apparatus of claim 12 wherein the mapping of converted data to the export buffer includes mapping the partitioned fields in a different order.

14. The apparatus of claim 9 wherein the data fields in the database format are in a DDIC format.

15. The apparatus of claim 9 wherein the open data format is at least one of: a CSV format and an XML format.

16. A method for transferring data using a data management application to an external application comprising:
receiving a data transfer command from an external application accessing the data management application;
based on the command, designating a plurality of data fields for transfer;
converting the plurality of data fields from a DDIC format to an open data format, wherein the open format includes at least one of: a CSV format and an XML format;
transferring, in parallel using a plurality of data transfer commands, the converted data fields to a temporary buffer;
after completing the transfers of the converted data fields, transferring the contents of the temporary buffer in a memory location associated with the first application; and
writing the converted data fields to a file associated with the external application, wherein the file is usable by the external application.

17. The method of claim 16 wherein the data fields are converted into partitioned fields.

18. The method of claim 17 wherein the partitioned fields include at least one of: a header, a body, and a footer.

19. The method of claim 17 further comprising:
after converting the plurality of data fields, mapping the converted data fields to an export buffer.

20. The method of claim 19 wherein the mapping of converted data to the export buffer includes mapping the partitioned areas in a different order.
